(19) United States
(12) Patent Application Publication
(10) Pub. No.: US 2017/0210025 A1
(43) Pub. Date: Jul. 27, 2017

(54) DISPOSABLE CUTTING BLADE FOR BLADE PORTIONER AND MOUNTING SYSTEM FOR BLADE

(71) Applicant: John Bean Technologies Corporation, Chicago, IL (US)

(72) Inventor: Alex Dopp, Kirkland, WA (US)

(73) Assignee: John Bean Technologies Corporation, Chicago, IL (US)

(21) Appl. No.: 15/004,910

(22) Filed: Jan. 23, 2016

(51) Int. Cl. B26D 7/26; B26D 5/00; B26D 7/06; B26D 5/30

(52) U.S. Cl. CPC B26D 7/2614; B26D 5/30; B26D 5/005; B26D 7/0625; B26D 2210/02

(57) ABSTRACT

An elongated blade (22) is mountable to a mounting assembly (29) of a portioning apparatus (10). The blade (22) uniformly tapers from the heel (70) to the tip (72) of the blade and is substantially straight along its entire length. The cutting edge (76) of the blade (22) extends substantially the full length of the lower edge of the blade and is of substantially constant profile. The heel end (78) of the blade is blunt, as is the spine (79) of the blade at the heel end, whereby compression forces are applied to these blunt surfaces by a blade holder (80) to secure the blade against the holder. An aperture (82) extends through the cheek portion (74) of the blade to engage with a pin or stud (116). The aperture (82) is held tightly against the pin or stud by a retainer (140), which is loadable against the holder (80), also causing the spine (79) of the blade to be pressed against the holder.

### TECHNICAL FIELD

The present invention relates to portioning or cutting workpieces (also “work products”), such as food products, and more particularly to portioning work products with a blade portioner employing a disposable blade.

### BACKGROUND

Workpieces, including food products, are portioned or otherwise cut into smaller units or portions in accordance with customer needs. Food products are commonly portioned either into uniform or specific sizes, weights, thicknesses, or other specifications. Examples of commonly portioned food products include beef steaks served in restaurants, chicken filets packaged in frozen dinners or chicken patties sized and shaped to fit within specific bun configurations. Fish is likewise routinely portioned into filets or steaks.

Much of the portioning of workpieces, and in particular food products, is now carried out with the use of high-speed portioning machines. These machines use various scanning techniques to ascertain the size, shape, and other physical characteristics of the workpiece as it is being advanced on a moving conveyor. This information is analyzed with the aid of a computer to determine how to most efficiently portion the workpiece into optimum or desired sizes, weights, thicknesses, or other criteria being used. For example, the customer may desire chicken breast portions in two or more different weight(s) or sizes. The chicken breast is scanned as it moves on an infeed conveyor belt, and a determination is made through the use of the computer as to how best to portion the chicken breast to the specific weight(s) desired by the customer.

Portioning of workpieces can be performed by a cutting blade that swings across the conveyor system through a gap defined by the ends of two adjacent conveyors that advance and support the workpieces being portioned. Typically, the blade is attached to a servo motor through an appropriate mounting system. The servo motor spins the blade very quickly through the gap. The workpiece progresses forwardly on the conveyor belts across the gap, thereby advancing between successive blade revolutions.

Because the intent of the blade portioner is to cut the workpiece to provide portions of controlled weight, thickness or other specifications, the timing of the blade passages must be very tightly controlled. The blade may be making approximately 20 to 30 cuts per second, but the blade typically stops briefly between each cut and waits a few milliseconds until the right time to rapidly accelerate to cutting speed to pass through the workpiece to cut the correct weight or other specification of the workpiece. The moment of inertia of the blade affects its ability to rapidly angularly accelerate and decelerate. Also, the strength of the blade affects its ability to withstand the rapid accelerations, decelerations, as well as the centrifugal force of high angular velocity and the cutting forces of passing through the workpiece at high speed. Any play in the connection to the blade mount, with rapidly reversing angular accelerations, would quickly widen out and cause issues.

When cutting blades, including blades used in portioning machines, become dull, they need to be replaced. Failure to do so can cause excessive kerf loss, thereby wasting the work product, for example, meat or other food products being cut. However, replacing blades in a portioning machine can be time consuming, and thus there may be a tendency to forego replacement of the blade until the end of a production shift or workday. As a result, a significant cost may have occurred in damaged work products.

Further, typical portioning blades are designed to be resharpened. This results in not only the initial expense of the blade, but also the cost of a machine to sharpen the blades as well as the cost of training personnel to sharpen the blades. Improperly trained personnel may do a poor job in sharpening blades, perhaps even damaging them, thereby requiring frequent repair and resulting in short lives of the blades. Further, the blades may be sharpened in a way that does not result in an actual sharp blade.

The present disclosure provides a disposable blade and a corresponding mounting or attachment for the blade that seeks to address the issues noted above.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

An elongate knife blade includes a cutting edge, a heel portion, a tip portion, and a cheek. The heel portion is configured to define an aperture extending through the cheek at the heel portion. The aperture is angled in a direction away from the heel portion toward the spine of the blade.

In a further aspect of the present disclosure, the aperture is in a form of a slot that is angled in a direction away from the heel portion toward the spine of the blade.

In accordance with a further aspect of the present disclosure, the knife blade at the heel portion of the blade terminates at a substantially blunt end capable of receiving and distributing a compression force applied thereto. Further, the spine in at least the heel portion of the blade is blunt.

In accordance with a further aspect of the present disclosure, the cutting edge of the knife blade is straight along the length of the knife blade and more specifically straight along the full length of the knife blade.

An elongate knife blade including a heel portion, a tip portion, a cheek, a cutting edge extending between the heel portion and a tip portion and a spine extending between the heel portion and a tip portion on the side of the blade opposite the cutting edge. The cheek of the blade is configured to define an aperture extending through the cheek. Further, the heel end portion of the blade opposite to the cheek is blunt.

In accordance with a further aspect of the present disclosure, the spine at the heel portion of the cutting blade is also blunt.

In accordance with a further aspect of the present disclosure, the aperture is in the form of a hole extending through the cheek portion. More specifically, the hole is in the form of an elongated slot. The slot can be oriented at an angle on the cheek so that in the direction away from the blunt heel end of the blade the slot extends toward the spine of the blade.

An elongated knife blade includes a heel, a tip, a spine, a cutting edge, and a cheek extending between the heel and the tip, with the cutting blade being straight along its entire length, and the cutting edge also extending substantially along the entire length of the blade.

In accordance with a further aspect of the present disclosure, the cutting blade is tapered substantially along its entire length.

In accordance with a further aspect of the present disclosure, an aperture in the form of an elongated slot extends through the check of the cutting blade. The elongated slot is angled relative to the spine so that the slot extends in the direction away from the heel of the cutting blade and toward the spine of the cutting blade.

A cutting blade includes a heel portion, a tip portion, a cheek portion extending between the heel portion and the tip portion, and the cutting edge extending between the heel portion and the tip portion. The cutting edge is substantially straight along its entire length. The cutting blade also includes at least one additional feature selected from (a) an aperture extending through the cheek portion for engagement with a holder or handle; (b) the end of the blade at the heel portion being blunt; (c) a spine extending between the heel and tip portions of the blade, (d) the spine being blunt at least at the heel portion of the blade; (e) the cutting edge of the blade extending substantially the full length of the blade; and (f) the blade being uniformly tapered substantially along the full length of the blade.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic view of an embodiment of a portioning system utilizing the cutting blade and cutting blade mounting assembly of the present disclosure;

FIG. 2 is an isometric view of a portioning blade and a mounting assembly therefor, taken from above and behind the blade and mounting assembly;

FIG. 3 is a view similar to FIG. 2 but with the parts shown in exploded view;

FIG. 4 is a view similar to FIG. 3 but taken from the opposite side of the blade and mounting system;

FIG. 5 is a view similar to FIG. 4 but in exploded view;

FIG. 6 is a side elevational view of FIG. 2;

FIG. 7 is a rear view of FIG. 6;

FIG. 8 is a front view of FIG. 6;

FIG. 9 is a side elevational view taken from the opposite side of FIG. 6;

FIG. 10 is a cross-sectional view of FIG. 9 taken along lines 10-10 thereof;

FIG. 11 is a further cross-sectional view of FIG. 9, taken along lines 11-11 thereof;

FIG. 12 is a top view of FIG. 6;

FIG. 13 is a bottom view of FIG. 6;

FIG. 14 is an isometric view of the blade itself taken from above and in front of the blade;

FIG. 15 is an isometric view of the blade, taken from the opposite side from FIG. 14, from below and behind the blade;

FIG. 16 is a side elevational view of FIG. 14;

FIG. 17 is a side elevational view of FIG. 14, taken from the side opposite FIG. 16;

FIG. 18 is a top view of FIG. 16;

FIG. 19 is a bottom view of FIG. 16;

FIG. 20 is a rear view of FIG. 16; and

FIG. 21 is a front view of FIG. 16.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order to not unnecessarily obscure various aspects of the present disclosure. Further, it will be appreciated that embodiments of the present disclosure may employ any combination of features described herein and process steps may be performed in sequences other than as specified.

The present application may include references to directions such as “forward,” “rearward,” “front,” “back,” “upward,” “downward,” “right hand,” “left hand,” “in,” “out,” “extended,” “advanced,” “retracted,” “proximal,” and “distal.” These references and other similar references in the present application are only to assist in helping describe and understand the present invention and are not intended to limit the present invention to these directions.

Also, with respect to the terminology used in the present application, for the most part, the word “parameter” is used to refer to a physical characteristic or feature such as length, width, thickness, weight or color. Also for the most part, the word “specification” refers to a particular parameter value or range, such as a length of between 110 and 120 mm, a weight that is no more than 30 grams, or the color blue. Also, in accordance with the present application, a specific instance of a parameter will have a value, and the value may or may not lie within a particular specification. In spite of the foregoing, it is within the scope of the present application to intermingle the use of the term “parameter” with the use of the term “specification.” For example, if the word “specification” is being utilized, this word should be interpreted broadly enough to also encompass the word “parameter,” and vice-versa. Also, in the present application, the word “characteristic” shall be a generic term that refers to “parameter” and/or “specification.”

The present application may include modifiers, such as the words “generally,” “approximately” or “substantially.” These terms are meant to serve as modifiers to indicate that the “dimension,” “shape,” or other physical parameter or specification in question need not be exact, but may vary as long as the function that is required to be performed can be carried out. For example, in the phrase “generally circular in shape,” the shape need not be exactly circular as long as the required function of the structure or process in question can be carried out. As another example, in the phrase “a substantially flat surface” the surface in question need not be exactly flat, but rather sufficiently flat that required function or requirement of the surface can be achieved.

In the following description, various embodiments of the present disclosure are described and illustrated. The systems, assemblies, apparatus and steps described and illustrated may be identified in the various embodiments by the same part number, but with an alpha suffix or other suffix. The descriptions of the parts/component steps of such systems, assemblies, apparatus, and methods that are the same or similar are not repeated so as to avoid redundancy in the present application.

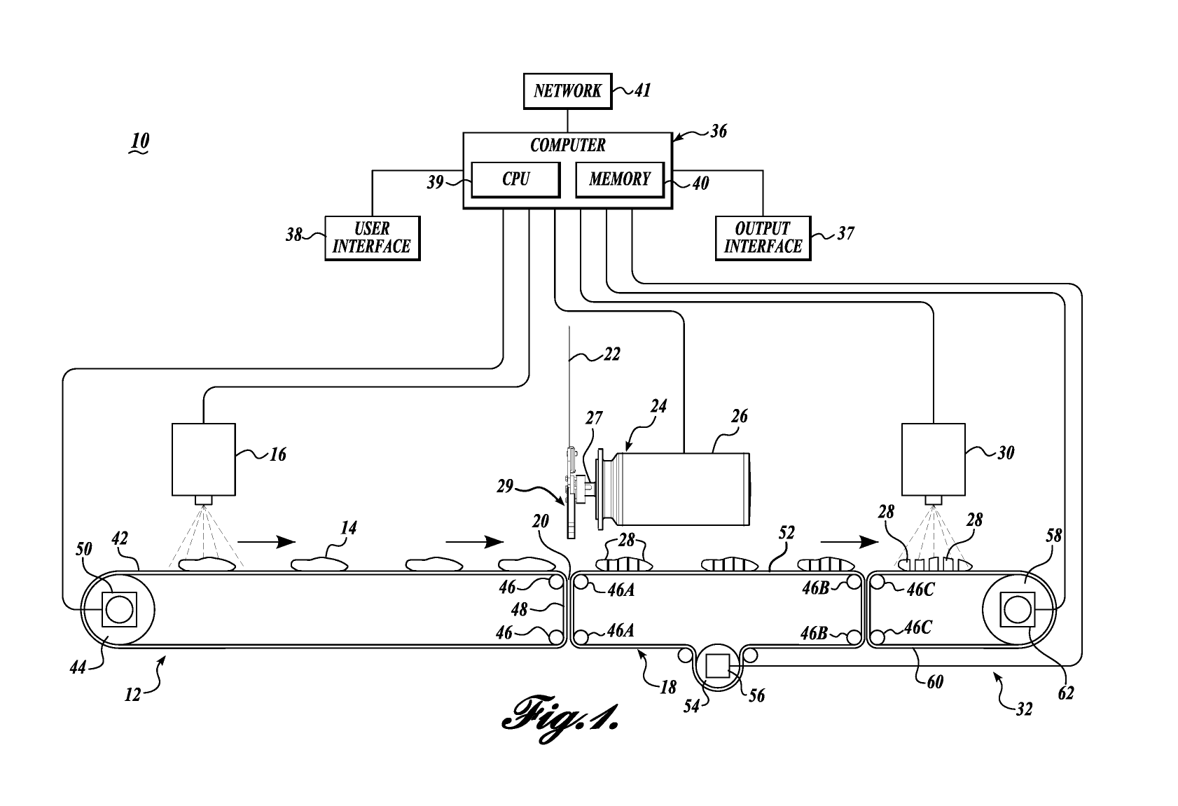

FIG. 1 schematically illustrates a portioning system 10 suitable for implementing an embodiment for the present disclosure. The portioning system 10 includes a first conveyor 12 for carrying workpieces (also “work products” or “products”) 14 to be portioned past a first scanning system 16 for scanning the workpieces prior to portioning. A second conveyor 18 is positioned closely adjacent the end of the first conveyor 12, thereby to define a narrow gap 20 therebetween. A cutting knife or blade 22 of a cutting device 24 is rotated through the gap 20. The cutting device 24 includes a servo motor 26 for powering the blade 22 to cut the workpieces 14 into desired units or portions 28. The blade 22 is mounted on the drive shaft 27 of the servo motor 26 with a mounting assembly (also “holder”) 29.

An optional second scanning system 30 may be positioned downstream of the cutting device 24 to scan and physically characterize the portions 28 as well as the nature, including the quality, of the cuts of the workpiece 14 performed by the cutting device 24. A third conveyor 32, operating at a higher speed than the second conveyor 18, receives the cut portions 28 from the second conveyor. The higher speed of the third conveyor 32 causes the portions to be separated so that the individual portions 28 can be analyzed, as well as the cuts made on the portions. The conveyors 12, 18 and 32 and the scanning systems 16 and 30, and the cutting device 22 are coupled to and controlled by a computer 36 (also “processor”). The computer may include an output interface or display 37, as well as a user input interface 38 (keyboard, mouse, etc.), a CPU 39, memory units 40, and other components that are commonly included in or used with computers. The computer 36 can be connected to a network 41. Also, rather than employing a computer 36 specifically for portioning system 10, a network computer system may be used instead.

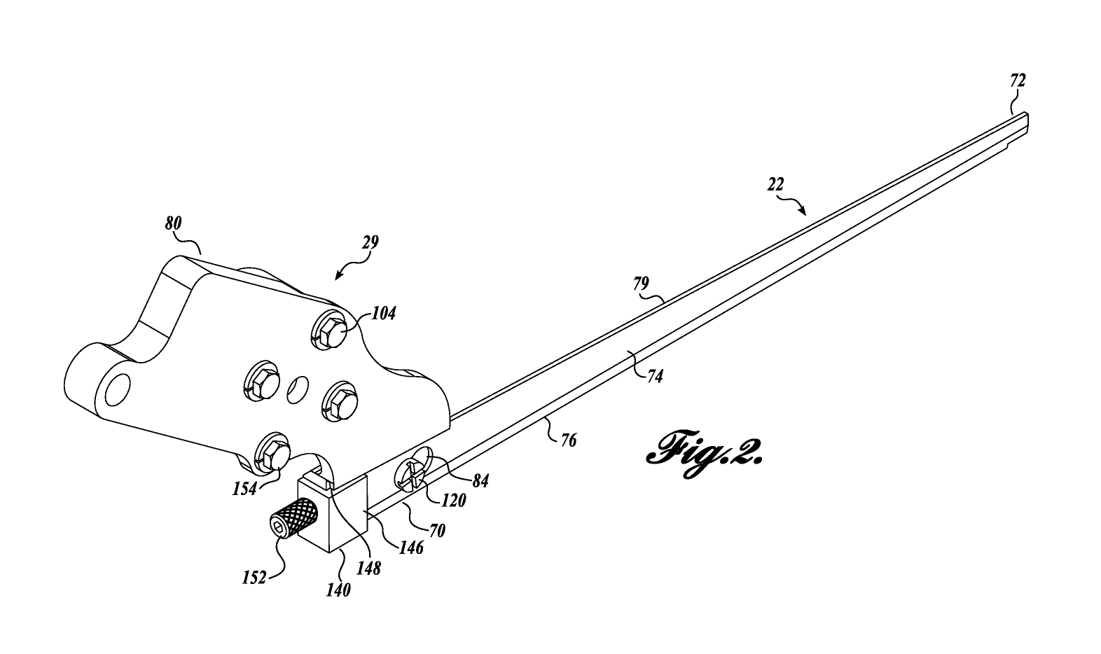

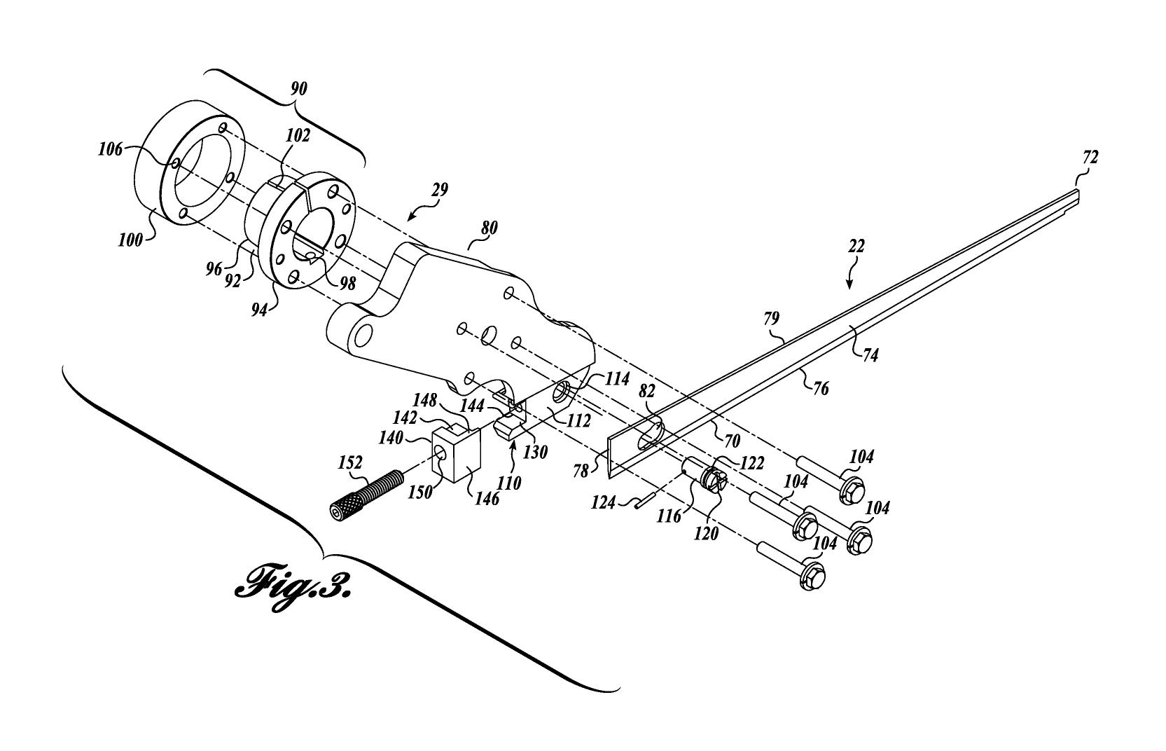

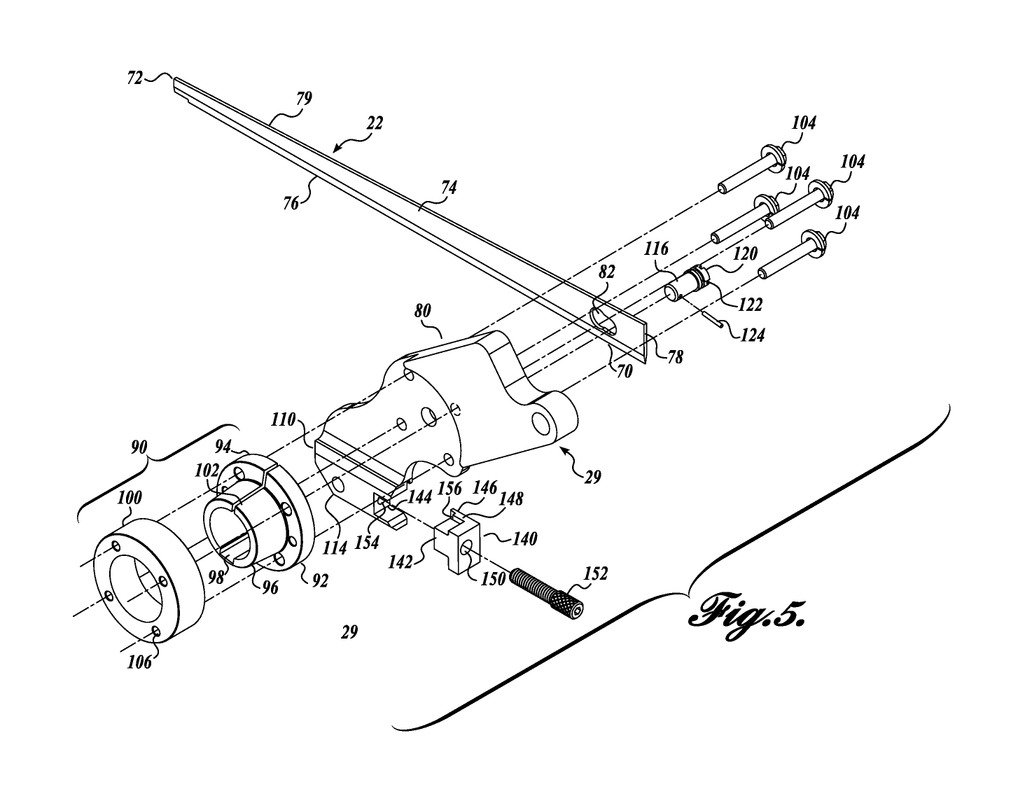

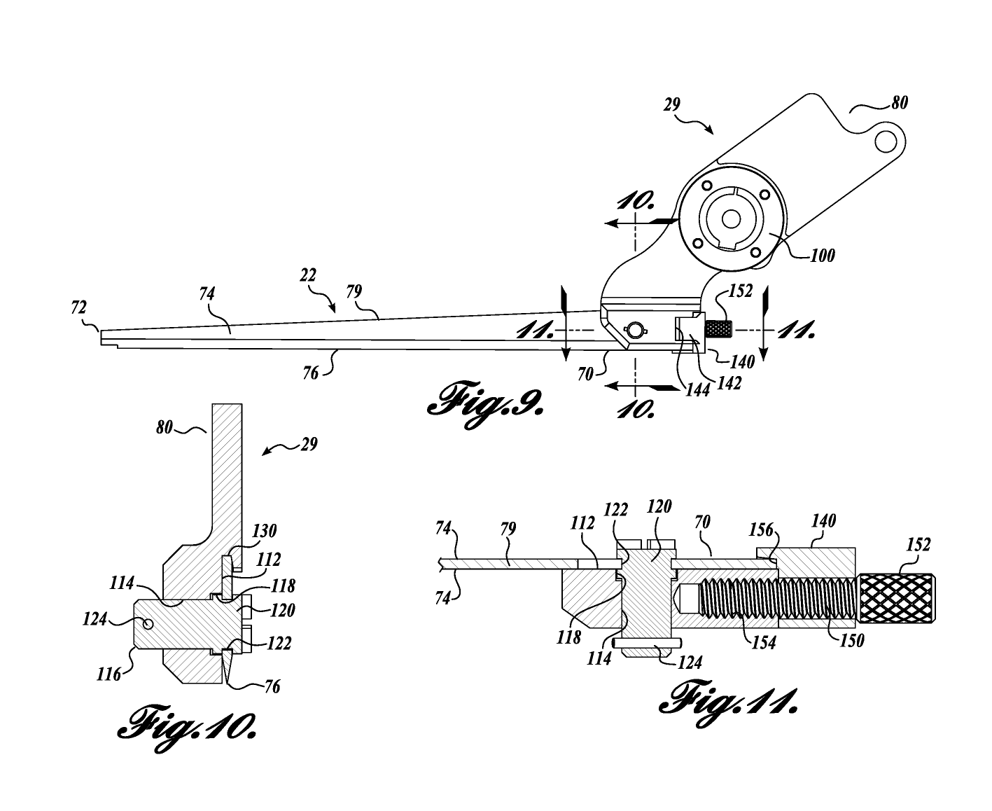

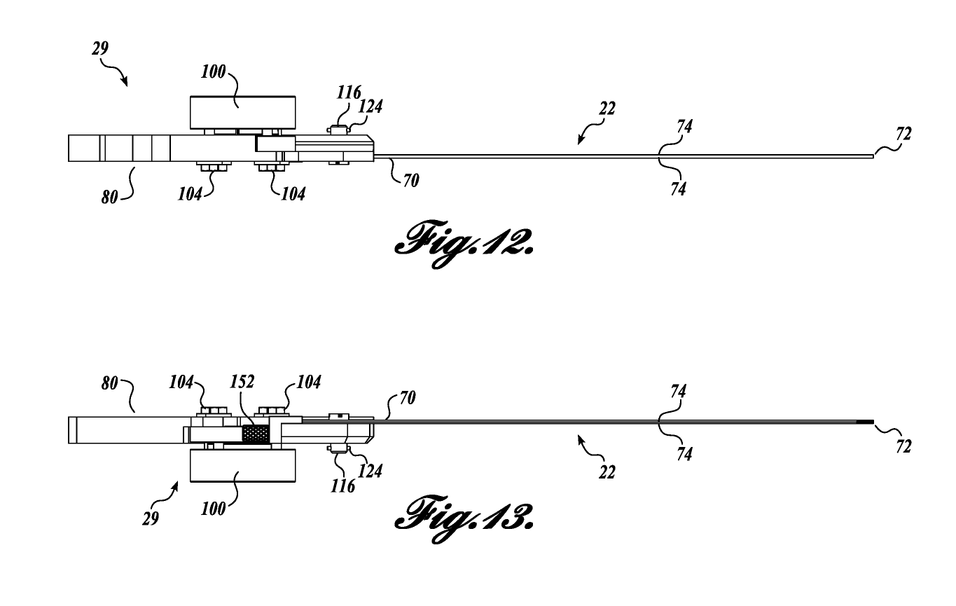

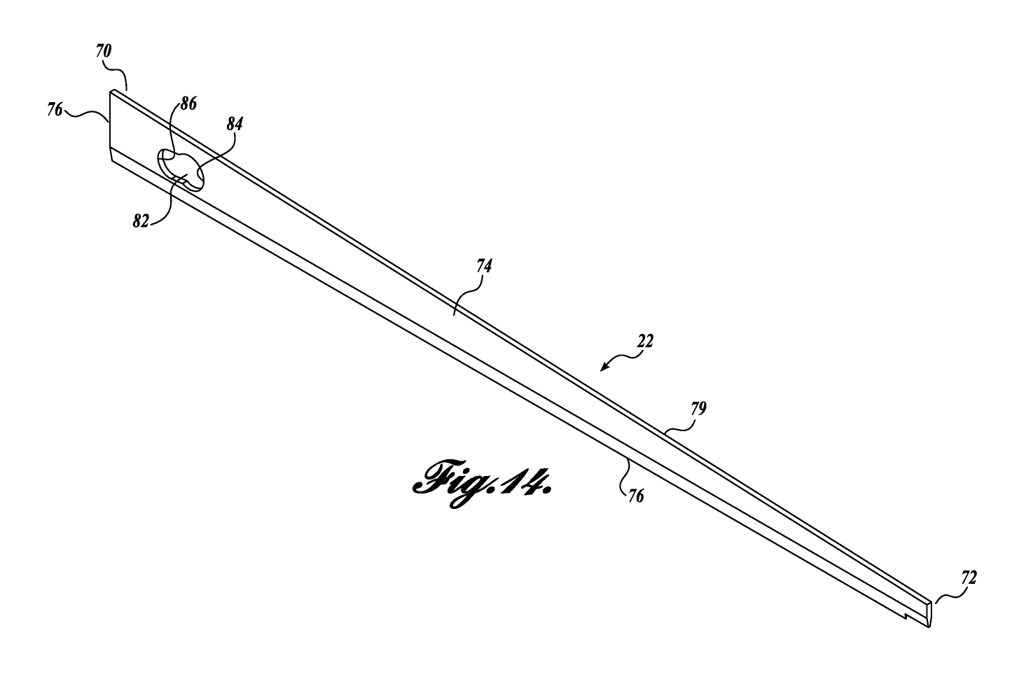

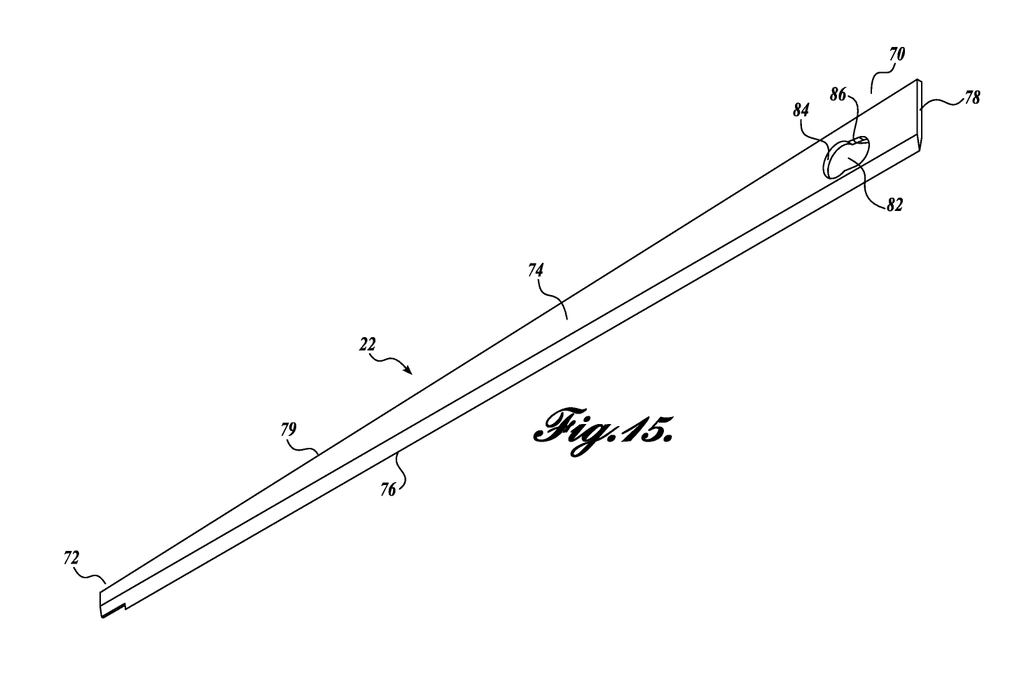

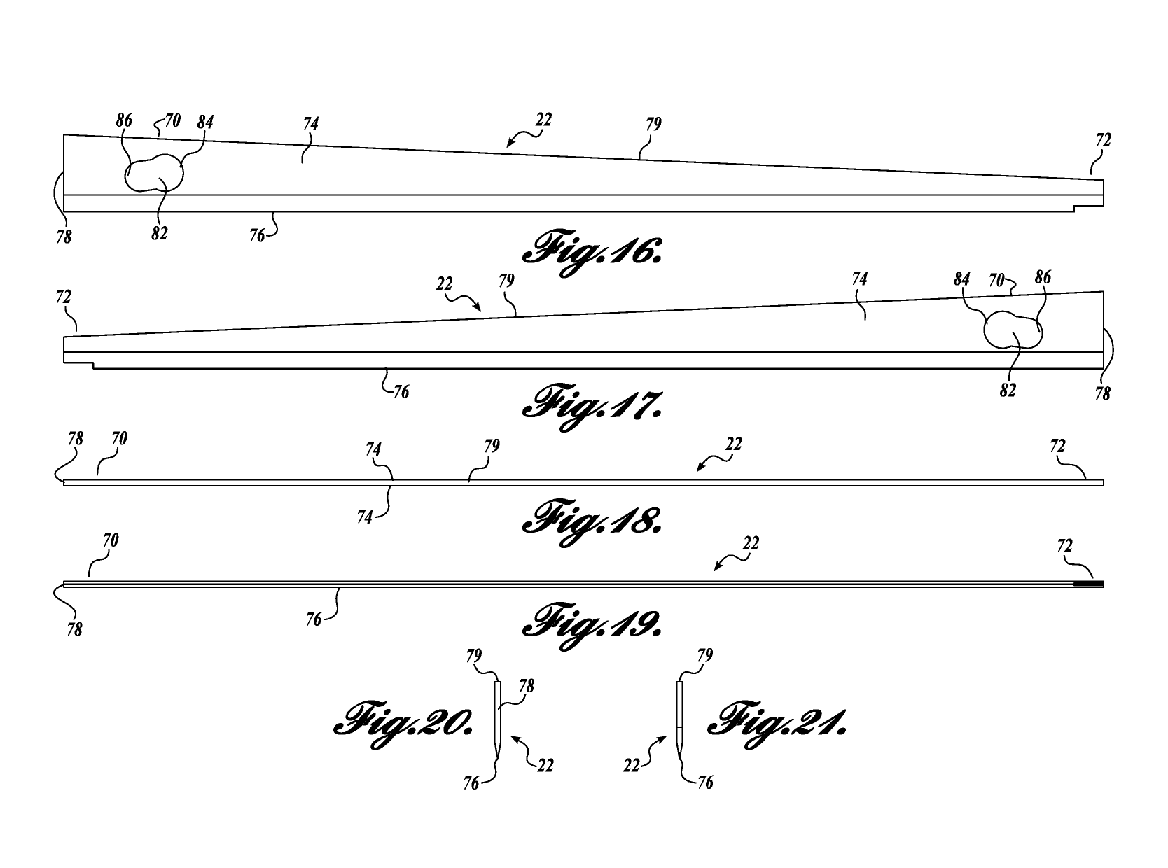

Next, referring specifically to FIGS. 2-21, the cutting blade 22 and its corresponding mounting assembly 29 are illustrated. In this regard, as described more fully below, the interconnection between the blade and the mounting assembly is designed to automatically tighten and become more secure as the blade rotates. This feature of the present disclosure will become more apparent from the description below.

As shown in FIGS. 2-21, blade 22 includes a wider heel portion 70 tapering to a narrower tip portion 72. As described more fully below, the heel portion attaches securely to the mounting assembly 29. The blade, as shown in FIGS. 2-21, is straight and is in the form of a constant taper from the heel portion 70 to the tip portion 72. Accordingly, the cheek 74 of the blade uniformly decreases in width along the length of the blade.

A cutting edge 76 extends substantially the full length of the lower edge portion of the blade, and is of substantially constant profile along the length of the blade except for at the tip 72 wherein the cutting edge is stepped down. Because the cutting edge 76 runs all the way to the heel end 78 of the blade, the typical stress concentration at the juncture of the cutting blade and heel is avoided. Moreover, by constructing the blade with a uniform cutting edge 76, the blade is easier and more economical to manufacture. Further, the edge portion 76 of the blade can be of a single bevel or double bevel, depending in part on the use of the blade.

As shown in FIGS. 3, 5, 15, 18, and 20, the heel end edge 78 of the blade is blunt. As discussed below, this enables the heel edge 78 to receive a pushing force from a retainer 140. Also, at least at the heel portion 70 of the blade, the spine (top edge) 79 of the blade is also blunt so as to load against the underside of the corresponding section of the head portion 80 of mounting assembly 29.

At the tip end 72, the blade 22 does not taper to a point, but is blunt so as to retain the structural integrity of the blade at the tip.

Referring specifically to FIGS. 2, 3, 5, 10, 11, and 14 through 17, an aperture 82 extends through the blade cheek 74 at the heel end portion 70. The aperture 82 shown in the Figures is in the form of a closed slot or a keyhole design having an enlarged head portion 84 and a smaller shank portion 86. Moreover, the slot, in the direction away from the heel edge 78 of the blade, is sloped “upwardly” toward the spine 79. Although the aperture 82 is illustrated as being in the form of a slot, other configurations of the aperture may be utilized. Further, although the aperture is illustrated as of closed configuration, the aperture can be of other configurations, for instance, the aperture can break out through the spine 79 of the blade 22.

The mounting assembly 29 consists in part of the generally planar mounting head 80 which is attachable to the drive shaft 27 of the motor 26 using an attachment collar assembly 90 that is perhaps most clearly shown in FIGS. 3, 4 and 5. The collar assembly 90 includes a sleeve section 92 having a circular flange portion 94 that is shaped and sized to bear against the side of the mounting head 80 opposite blade 22, see especially FIGS. 5 and 9. The sleeve section 92 also includes a clamping collar portion 96 protruding from flange portion 94 that is sized to engage over drive shaft 27 of the servo motor 26. In this regard, a keyway 98 extends along the interior of the clamp portion 96 to engage either a spine formed in drive shaft 27 or a key that engages into the keyway 98 and a similar keyway provided in the drive shaft 27 in the standard manner.

The mounting collar assembly 90 also includes a clamping ring 100 having an inside diameter sized to closely fit over the clamp portion 96 of the sleeve section 92. As shown in FIG. 5, the outer diameter of the clamp portion 96 is tapered in the direction away from the flange 94. As a consequence, as the clamping ring 100 is further engaged over the clamp portion 96, the clamp portion 96 more tightly squeezes around drive shaft 27. In this regard, a slot 102 extends longitudinally through the sleeve section 92 to permit the clamping movement of the clamp portion 96, see especially FIGS. 3 and 5.

The collar assembly 90 is mounted to mounting head 80 by hardware members 104 that extend through close-fitting clearing holes formed in mounting head 80, through corresponding close-fitting clearance holes formed in the flange 94 of the sleeve structure 92 to engage with threaded holes 106 formed in the clamping ring 100. As can be appreciated, as the hardware members 104 are tightened into engagement with the clamping ring 100, the sleeve section is clamped about the drive shaft 27 of the drive motor 26.

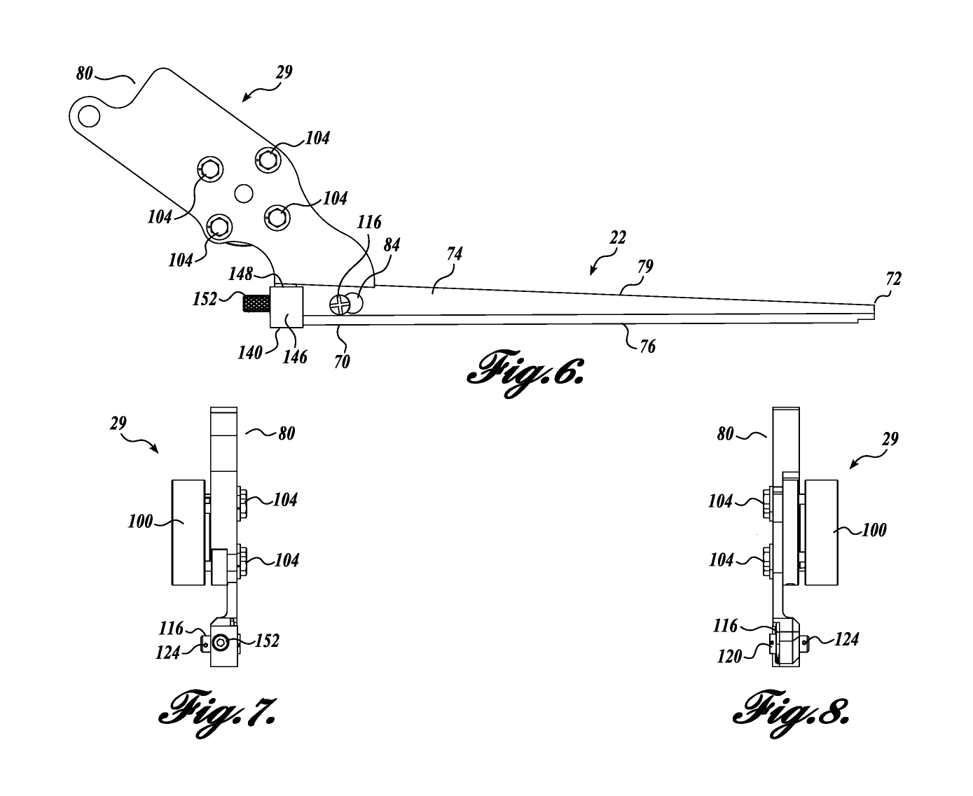

The mounting head 80 includes a mounting lug 110 which presents a flat face surface 112 to bear against the adjacent cheek side of blade 22. A through-hole 114 extends through the mounting lug 110 for receiving a close-fitting pin 116. As shown in FIGS. 10 and 11, the through-hole 114 has a shallow counter bore 118 that is sized to closely receive the enlarged head portion 120 of pin 116. The purpose of the counter bore 118 and enlarged head 120 is to position a circumferential slot 122 extending around the head portion 120 of the pin 116 relative to face 112 of the lug 110. The slot 122 is sized to closely receive the cheek portion 74 (within aperture 82) of the end portion of blade 22 therein, see FIGS. 10 and 11. The pin 116 is nominally retained within the lug 110 by a cross pin 124 extending through a cross hole formed in pin 116 opposite head 120.

When the blade 22 is engaged with the mounting head 80, the end portion 86 of the blade slot 82 closest to the heel edge 72 of the blade is engaged with the slot of the pin 116. Also, the spine 79 of the blade 22 is engaged within a slot 130 that is undercut in the mounting head 80 along the underside of the top of mounting lug 110 so as to form a continuation of face 112. As described more fully below, as the blade 22 is tightened into engagement with mounting assembly 29, the blunt edge of the spine 79 bears against the base of the slot 130.

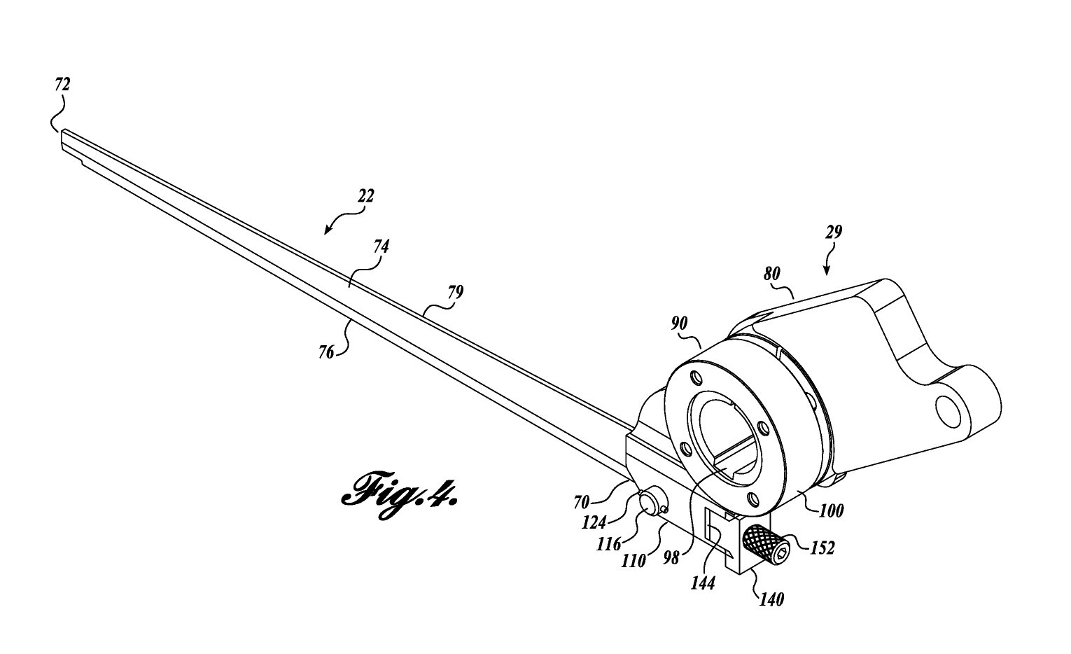

A retainer 140 is provided to press against the blunt heel edge 78 of the blade 22 so as to load the blade against the pin 116 at the near end 86 of the slot 82, as well as load the spine 79 of the blade against the lug slot 130. To this end, the retainer 140 is generally cubic in shape, having a reduced height forward insert section 142 sized to fit closely within a rearwardly facing slot 144 formed in the rear portion of lug 110. The retainer 140 also includes a side flange portion 146 that overlaps the outward facing surface of the blade cheek 74 (see especially FIG. 11), with the upper edge 148 of the flange 146 engaging closely underneath the underside of the mounting head 80 that extends laterally over the blade cheek 74 (see especially FIG. 6). This close fit assists in keeping the retainer 140 in correct orientation relative to blade 22 and mounting head 80.

A through-hole 150 extends horizontally through the retainer 140 to receive a clamping bolt 152 that threadably engages within a threaded hole 154 formed in lug 110, see FIGS. 3, 5, and 11. The bolt 152, when engaged with the threaded hole 154, pushes the retainer 140 forward so that a forward ledge portion 156 of the retainer in turn presses forward against the blunt heel edge 78 of the blade 22, thereby forcing the adjacent end 86 of the slot 82 of the blade against the retaining pin 116, see FIGS. 5 and 11. Because the slot 82 is sloped or angled relative to the spine 79 of the blade, as the blade moves forward relative to pin 116, the blade also rises and moves upwardly relative to the holder 80, thereby wedging the spine 79 into the slot 130 of the holder 29. Consequently, the blade 22 is held very securely in engagement with the holder 29.

Further, it will be appreciated that as the blade 22 rotates, the centrifugal force on the blade tends to urge the blade away from its center of rotation, causing the blade to seat more securely with both the retaining pin 116 and the slot 130 formed in the mounting head 80. Thus, the operation of the blade 22 forces the blade in retention engagement with the mounting assembly 29.

The blade 22 may be constructed from various materials, including, for example, stainless steel. Stainless steel provides significant structural strength to the blade and also is capable of retaining a sharp cutting edge through significant use of the blade. Further, by forming the blade in a straight tapered shape, the blade can be made from stock material without any significant waste. In this regard, the blades can be laid out in the stock material opposite end to opposite end. The economical manufacture of the blade contributes to the ability of the blade to be disposable rather than having to be sharpened after becoming dull. Further, the above-described mounting of the blade enables the blade to be quickly disassembled by simply loosening bolt 152 so that the blade may be pushed rearwardly relative to the mounting head 80 to disengage the slot 82 from the pin 116. A replacement blade can be quickly and easily installed by simply reversing this process.

It will also be appreciated that by tapering the blade along its length, the moment of inertia of the blade can be minimized, which facilitates the ability to rapidly accelerate and decelerate the blade while not overworking or overloading the motor 26. As noted above, the blade 22 may be required to rotate at a speed of up to 30 or more revolutions per second, and during each revolution, the blade momentarily stops between cuts as well as between workpieces, and then accelerates to make the next cut. It will be appreciated that the moment of inertia of the blade can have a significant effect on the ability to accelerate and decelerate the blade at the high levels of revolution required of the blade.

It will also be appreciated that rather than using a slot 82, other shapes or types of apertures can be employed to provide the same or similar secure engagement between the blade 22 and mounting assembly 29.

Further, the removable pin 116 can be replaced by a permanent stud or other member that serves the same function as the pin 116.

While illustrative embodiments have been illustrated and described, it will be appreciated that various changes can be made therein without departing from the spirit and scope of the invention.

In this regard, in one embodiment of the present disclosure, the blade 22 is designed and sized to be used in conjunction with portioning system 10. In this regard, the blade 22 can have a total length in the range of about 8 to 14 inches, and more specifically, a length in the range of about 10 to 12 inches. The blade may have a width at the heel of about 0.887 inch to about 1.25 inches, and a width at the tip in the range of about 0.5 to 1 inch. Further, the blade may have a thickness of about 0.05 to 0.1 inch, and more specifically a thickness in the range of about 0.063 to about 0.075 inch. However, one or more of these dimensions may vary beyond the stated dimension for use in a portioning machine. Further, if the blade is to be used in a different type of machine, or for a different purpose, the dimensions of the blade can be adjusted accordingly. In sum, the scope of the present invention is not limited by the foregoing dimensions, but rather is defined by the following claims.

The embodiments of the invention in which an exclusive property or privilege is claimed are defined as follows:

1. An elongate knife blade comprising a cutting edge, a spine, a heel portion, a tip portion, and a cheek, the heel portion configured to define an aperture extending through the cheek at the heel portion, the aperture angled in the direction away from the heel portion toward the spine of the blade.

2. The knife blade according to claim 1, wherein the aperture comprises a slot, the slot angled in the direction away from the heel portion toward the spine of the blade.

3. The knife blade according to claim 1, wherein the knife blade at the heel portion of the knife blade terminating at a substantially blunt end capable of receiving and distributing a compression force applied thereto.

4. The knife blade according to claim 1, the spine being blunt in at least the heel portion of the blade.

5. The knife blade according to claim 1, wherein the cutting edge of the knife blade is straight along the length of the knife blade.

6. The knife blade according to claim 1, wherein the cutting edge is straight along the full length of the cutting edge.

7. A cutting blade comprising a heel portion, a tip portion, a cheek, a cutting edge extending between the heel portion and the tip portion, a spine extending between the heel portion and tip portion on the side of the blade opposite the cutting edge, the cheek of the cutting blade configured to define an aperture extending through the cheek and wherein the heel end of the blade, opposite the tip portion, being blunt.

8. The cutting blade according to claim 7, wherein the spine at the heel portion of the cutting blade is blunt.

9. The cutting blade according to claim 7, wherein the aperture through the cheek comprises a hole extending through the cheek.

10. The cutting blade according to claim 9, wherein the hole through the cheek is in the form of an elongated slot.

11. The cutting blade according to claim 10, wherein the elongated slot is angled in the direction away from the blunt heel end of the blade and toward the spine of the blade.

12. The cutting blade according to claim 7, wherein the cutting edge is substantially straight along the entire length of the blade between the heel and the tip portions.

13. The cutting blade according to claim 7, wherein the cutting edge of the blade extends substantially the full length of the blade.

14. An elongate cutting blade comprising a heel, a tip, a spine, a cutting edge, and a cheek extending between the heel and the tip, the cutting blade being straight along its entire length and the cutting edge extending substantially along the entire length of the blade.

15. The cutting blade according to claim 14, wherein the cutting blade is tapered substantially along its entire length.

16. The cutting blade according to claim 14, comprising an aperture extending through the cheek of the cutting blade in the heel of the cutting blade.

17. The cutting blade according to claim 16, wherein the aperture is in the form of an elongated slot.

18. The cutting blade according to claim 17, wherein the elongated slot is angled relative to the spine, the slot extending in the direction away from the heel of the cutting blade and toward the spine of the cutting blade.

19. The cutting blade according to claim 15, wherein the end of the cutting blade at the heel of the cutting blade is blunt and capable of receiving and distributing a force there against.

20. The cutting blade according to claim 15, wherein the spine at least in the region of the heel portion is blunt.

21. A cutting blade comprising a heel portion, a tip portion, a check portion extending between the heel portion and the tip portion, and a cutting edge extending between the heel portion and the tip portion, the cutting edge being substantially straight along its entire length, the cutting blade further comprising at least one of the following:
(a) an aperture extending through the cheek portions for engagement with a holder or handle;
(b) the end of the blade at the heel portion being blunt, the blunt end capable of receiving a force directed toward the tip portion of the blade;
(c) a spine extending between the heel and tip portion of the blade, the spine being blunt at least in the heel portion of the blade capable of receiving a force there against;
(d) the cutting edge of the blade extending substantially the entire length of the blade; and
(e) the cutting blade being uniformly tapered substantially along the full length of the blade.

22. The cutting blade according to claim 21, wherein the blade being tapered substantially along the full length of the blade, with the taper being substantially straight.

23. The cutting blade according to claim 21, wherein the aperture extending through the cheek portion of the blade comprising a slot.

24. The cutting blade according to claim 23, wherein the slot is angled in the direction away from the heel end of the blade toward the spine of the blade.
